(19) United States
(12) Patent Application Publication
(10) Pub. No.: US 2007/0076812 A1
(43) Pub. Date: Apr. 5, 2007

(54) Technique to provide proprietary MIMO format in a product and ability to support a new standard when the new standard is developed

(75) Inventor: Jason A. Trachewsky, Menlo Park, CA (US)

Correspondence Address: GARLICK HARRISON & MARKISON, P.O. BOX 160727, AUSTIN, TX, 78716-0727, US

(73) Assignee: Broadcom Corporation, Irvine, CA (US)

(21) Appl. No.: 11/529,041

(22) Filed: Sep. 28, 2006

Related U.S. Application Data
(60) Provisional application No. 60/722,805, filed on Sep. 30, 2005.

(51) Int. Cl. H04L 1/02

(52) U.S. Cl. 375/267

(57) ABSTRACT

A technique to provide proprietary MIMO format in a product and ability to support a new standard when the new standard is developed for wireless communication in a MIMO system. A product may include a “hook” to allow for the protection of existing proprietary MIMO mode of operation, once a new MIMO standard is made available to the industry. Once an access point device is upgraded to the new MIMO standard for communicating, the hook may be used to elicit a certain response from a given station to protect the proprietary MIMO mode for communicating with those stations not yet upgraded. In one technique, a proprietary information element in a beacon is used as the hook and RTS+CTS or CTS-to-self condition are used to inform the access point device to continue use of the proprietary MIMO mode.

### PRIORITY INFORMATION

This application claims the benefit of priority to U.S. Provisional Patent Application Ser. No. 60/722,805; filed Sep. 30, 2005; and titled “Technique to provide proprietary MIMO format in a product and ability to support a new standard when the new standard is developed,” which is incorporated herein by reference.

### BACKGROUND OF THE INVENTION

1. Technical Field of the Invention

The embodiments of the invention relate to wireless communications and more particularly to a technique to upgrade to a new multiple-input and multiple-output (MIMO) format when the new format is made available.

2. Description of Related Art

Communication systems are known to support wireless and wire lined communications between wireless and/or wire lined communication devices. Such communication systems range from national and/or international cellular telephone systems, the Internet and to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, et cetera, communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via a public switch telephone network, via the Internet, and/or via some other wide area network.

For each wireless communication device to participate in wireless communications, it typically includes a built-in radio transceiver (i.e., receiver and transmitter) or is coupled to an associated radio transceiver (e.g., a station for in-home and/or in-building wireless communication networks, RF modem, etc.). The receiver may be coupled to an antenna and the receiver may include a low noise amplifier, one or more intermediate frequency stages, a filtering stage, and a data recovery stage. The low noise amplifier receives inbound RF signals via the antenna and amplifies them. The one or more intermediate frequency stages mix the amplified RF signals with one or more local oscillators to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

The transmitter typically includes a data modulation stage, one or more intermediate frequency stages, and a power amplifier stage. The data modulation stage converts raw data into baseband signals in accordance with a particular wireless communication standard. The one or more intermediate frequency stages mix the baseband signals with one or more local oscillators to produce RF signals. The power amplifier amplifies the RF signals prior to transmission via an antenna.

In many systems, the transmitter may include one antenna for transmitting the RF signals, which are received by a single antenna, or multiple antennas, of a receiver. When the receiver includes two or more antennas, the receiver generally selects one of them to receive the incoming RF signals. In this instance, the wireless communication between the transmitter and receiver is a single-output-single-input (SISO) communication, even if the receiver includes multiple antennas that are used as diversity antennas (i.e., selecting one of them to receive the incoming RF signals). For SISO wireless communications, a transceiver includes one transmitter and one receiver. Currently, most wireless local area networks (WLAN) that are IEEE 802.11, 802.11a, 802,11b, or 802.11g employ SISO wireless communications.

Other types of wireless communications include single-input-multiple-output (SIMO), multiple-input-single-output (MISO), and multiple-input-multiple-output (MIMO). In a SIMO wireless communication, a single transmitter processes data into radio frequency signals that are transmitted to a receiver. The receiver includes two or more antennas and two or more receiver paths. Each of the antennas receives the RF signals and provides them to a corresponding receiver path (e.g., LNA, down conversion module, filters, and ADCs). Each of the receiver paths processes the received RF signals to produce digital signals, which are combined and then processed to capture the transmitted data.

For a multiple-input-single-output (MISO) wireless communication, the transmitter includes two or more transmission paths (e.g., digital to analog converter, filters, up-conversion module, and a power amplifier) that each converts a corresponding portion of baseband signals into RF signals, which are transmitted via corresponding antennas to a receiver. The receiver includes a single receiver path that receives the multiple RF signals from the transmitter.

For a multiple-input-multiple-output (MIMO) wireless communication, the transmitter and receiver each include multiple paths. In such a communication, the transmitter parallel processes data using a spatial and time encoding function to produce two or more streams of data. The transmitter includes multiple transmission paths to convert each stream of data into multiple RF signals. The receiver receives the multiple RF signals via multiple receiver paths that recapture the streams of data utilizing a spatial and time decoding function. The captured received signals are jointly processed to recover the original data.

With the various types of wireless communications (e.g., SISO, MISO, SIMO, and MIMO) and standards (e.g., IEEE 802.11, IEEE 802.11a, IEEE 802.11b, IEEE 802.11g, IEEE 802.11n, extensions and modifications thereof), a large number of combination of types and standards are possible. In particular, a number of SISO standards (such as the afore-mentioned 802.11a/b/g standards) are available for implementation in wireless devices. However, for devices utilizing MIMO communication, no industry standard is currently available. Accordingly, without agreement to an industry MIMO standard (such as the projected 802.11n), manufactures of these wireless communication devices have established their own proprietary communication formats. A particular proprietary format is implemented in that vendor's product and, in some case, may be shared by a group of vendors. Yet, without an established industry MIMO standard, a number of separate proprietary products are available in the market place.

Whenever a new MIMO standard is developed by the industry, the current generation of MIMO communication products may be made obsolete, unless these older products are capable of accepting the new standard and operating in the new environment. A difficulty in upgrading to the new standard lies in the practicality of upgrading all devices within a given system. For example, if an access point device (such as a router) receives an upgrade to a new MIMO standard, but only some of the station devices communicating with the router receives the equivalent upgrade, the non-upgraded devices may not function within the system with the upgraded router. Ideally, in such partial system upgrades, it would be advantageous for both upgraded and non-upgrade devices to be functional. However, if some proprietary MIMO formats are appreciably similar to the new MIMO standard, it may be difficult for some devices to differentiate the two.

Accordingly, by providing a particular upgrading scheme that allows selection between proprietary MIMO formats and a new MIMO standard, systematic or incremental upgrading may be achieved for a group of communicating devices.

### SUMMARY OF THE INVENTION

The present invention is directed to apparatus and methods of operation that are further described in the following Brief Description of the Drawings, the Detailed Description of the Embodiments of the Invention, and the Claims. Other features and advantages of the present invention will become apparent from the following detailed description of the embodiments of the invention made with reference to the accompanying drawings.

### BRIEF DESCRIPTION OF THE SEVERAL VIEWS OF THE DRAWINGS

FIG. 1 is a block schematic diagram illustrating a wireless communication system in accordance with one embodiment of the present invention.

FIG. 2 is a block schematic block diagram illustrating a wireless communication device in accordance with one embodiment of the present invention.

FIG. 3 is a diagram of a communication system showing an access point and multiple stations in which one or more stations are capable of MIMO communication.

FIG. 4A shows contents of a memory device in which legacy and proprietary MIMO software are selected for use when legacy and proprietary modes of operation are selected at an access point.

FIG. 4B shows contents of a memory device in which legacy and new MIMO standard software are selected for use when legacy and new MIMO modes of operation are selected at an access point.

FIG. 5A shows an example beacon from the access point in which a proprietary element frame is sent in the beacon to a station.

FIG. 5B shows an example communication link that is used between an access point and a station to initiate data transfer by maintaining a proprietary MIMO mode of communication.

FIG. 5C shows another example communication link that is used between an access point and a station to initiate data transfer by maintaining a proprietary MIMO mode of communication.

FIG. 6 shows an example operation for a device operating as an access point in which a response from a station determines which mode of communication is used by the access point.

FIG. 7 is an example illustration of a state machine that is used by an access point to select between the use of proprietary MIMO mode of communication or the new MIMO standard mode of communication with a given station.

### DETAILED DESCRIPTION OF THE EMBODIMENTS OF THE INVENTION

The embodiments of the present invention may be practiced in a variety of settings that implement baseband processing in a wireless communication device.

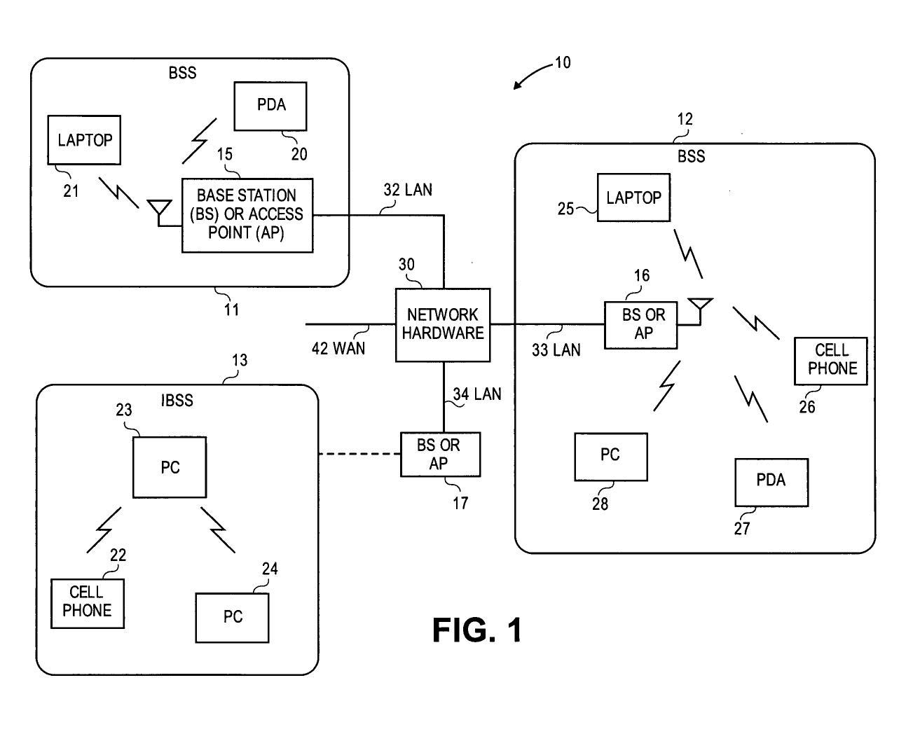

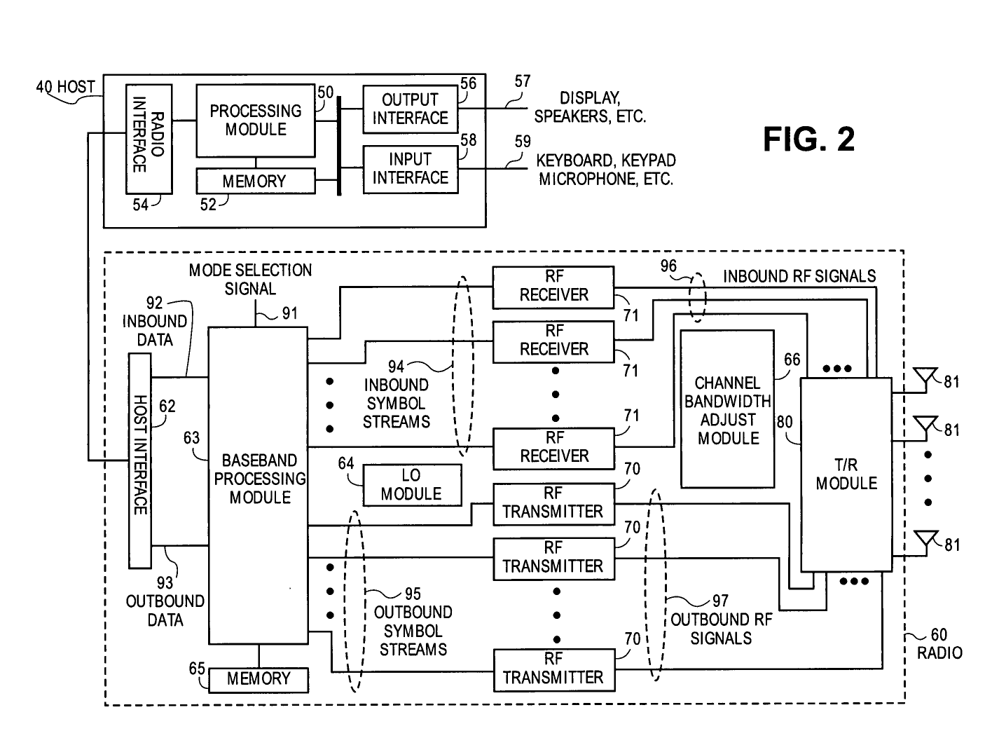

FIG. 1 is a schematic block diagram illustrating a communication system 10 that includes a plurality of base stations and/or access points (BS/AP) 15, 16, 17, a plurality of wireless communication devices 20-28 and a network hardware component 30. Network hardware component 30, which may be a router, switch, bridge, modem, system controller, et cetera, may provide a wide area network (WAN) coupling 31 for communication system 10. Furthermore, wireless communication devices 20-28 may be of a variety of devices, including laptop computers 21, 25; personal digital assistants (PDA) 20, 27; personal computers (PC) 23, 24, 28; and/or cellular telephones (cell phone) 22, 26. The details of the wireless communication devices shown is described in greater detail with reference to FIG. 2.

Wireless communication devices 22, 23, and 24 are shown located within an independent basic service set (IBSS) area 13 and these devices communicate directly (i.e., point to point). In this example configuration, these devices 22, 23, and 24 typically communicate only with each other. To communicate with other wireless communication devices within system 10 or to communicate outside of system 10, devices 22-24 may affiliate with a base station or access point, such as BS/AP 17, or one of the other BS/AP units 15, 16.

BS/AP 15, 16 are typically located within respective basic service set (BSS) areas 11, 12 and are directly or indirectly coupled to network hardware component 30 via local area network (LAN) couplings 32, 33. Such couplings provide BS/AP 15, 16 with connectivity to other devices within system 10 and provide connectivity to other networks via WAN connection 31. To communicate with the wireless communication devices within its respective BSS 11, 12, each of the BS/AP 15, 16 has an associated antenna or antenna array. For instance, BS/AP 15 wirelessly communicates with wireless communication devices 20, 21, while BS/AP 16 wirelessly communicates with wireless communication devices 25-28. Typically, the wireless communication devices register with a particular BS/AP 15, 16 to receive services within communication system 10. As illustrated, when BS/AP 17 is utilized with IBSS area 13, LAN coupling 17 may couple BS/AP 17 to network hardware component 30.

Typically, base stations are used for cellular telephone systems and like-type systems, while access points are used for in-home or in-building wireless networks (e.g., IEEE 802.11 and versions thereof, Bluetooth, and/or any other type of radio frequency based network protocol). Regardless of the particular type of communication system, each wireless communication device includes a built-in radio and/or is coupled to a radio.

FIG. 2 is a schematic block diagram illustrating a wireless communication device that includes a host 40 and an associated radio 60. Host 40 may be one of the devices 20-28 shown in FIG. 1. For cellular telephone hosts, radio 60 is typically a built-in component. For personal digital assistant hosts, laptop hosts, and/or personal computer hosts, radio 60 may be built-in or an externally coupled component.

As illustrated, host 40 includes a processing module 50, memory 52, radio interface 54, input interface 58 and output interface 56. Processing module 50 and memory 52 execute corresponding instructions that are typically done by the host device. For example, for a cellular telephone host device, processing module 50 may perform the corresponding communication functions in accordance with a particular cellular telephone standard.

Generally, radio interface 54 allows data to be received from and sent to radio 60. For data received from radio 60 (such as inbound data 92), radio interface 54 provides the data to processing module 50 for further processing and/or routing to output interface 56. Output interface 56 provides connectivity on line 57 to an output device, such as a display, monitor, speakers, et cetera, in order to output the received data. Radio interface 54 also provides data from processing module 50 to radio 60. Processing module 50 may receive outbound data on line 59 from an input device, such as a keyboard, keypad, microphone, et cetera, via input interface 58 or generate the data itself. For data received via input interface 58, processing module 50 may perform a corresponding host function on the data and/or route it to radio 60 via radio interface 54.

Radio 60 includes a host interface 62, a baseband processing module 63, memory 65, one or more radio frequency (RF) transmitter units 70, a transmit/receive (T/R) module 80, one or more antennas 81, one or more RF receivers 71, a channel bandwidth adjust module 66, and a local oscillation module 64. Baseband processing module 63, in combination with operational instructions stored in memory 65, executes digital receiver functions and digital transmitter functions. The digital receiver functions include, but are not limited to, digital intermediate frequency to baseband conversion, demodulation, constellation demapping, decoding, de-interleaving, fast Fourier transform, cyclic prefix removal, space and time decoding, and/or descrambling. The digital transmitter functions include, but are not limited to, scrambling, encoding, interleaving, constellation mapping, modulation, inverse fast Fourier transform, cyclic prefix addition, space and time encoding, and digital baseband to IF conversion.

Baseband processing module 63 may be implemented using one or more processing devices. Such processing device(s) may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

Memory 65 may be a single memory device or a plurality of memory devices. Such a memory device may be a read-only memory, random access memory, volatile memory, non-volatile memory, static memory, dynamic memory, flash memory, and/or any device that stores digital information. Note that when processing module 63 implements one or more of its functions via a state machine, analog circuitry, digital circuitry, and/or logic circuitry, the memory storing the corresponding operational instructions may be embedded with the circuitry comprising the state machine, analog circuitry, digital circuitry, and/or logic circuitry.

In operation, radio 60 receives outbound data 93 from host 40 via host interface 62. Baseband processing module 63 receives outbound data 93 and based on a mode selection signal 91, produces one or more outbound symbol streams 95. Mode selection signal 91 typically indicates a particular mode of operation that is compliant with one or more specific modes of the various IEEE 802.11 standards. For example, in one embodiment mode selection signal 91 may indicate a frequency band of 2.4 GHz, a channel bandwidth of 20 or 22 MHz and a maximum bit rate of 54 megabits-per-second. In this general category, mode selection signal 91 may further indicate a particular rate ranging from 1 megabit-per-second to 54 megabits-per-second, or higher.

In addition, mode selection signal 91 may indicate a particular type of modulation, which includes, but is not limited to, Barker Code Modulation, BPSK, QPSK, CCK, 16 QAM and/or 64 QAM, as well as others. Mode selection signal 91 may also include a code rate, a number of coded bits per subcarrier (NBPSC), coded bits per OFDM symbol (NCBPS), and/or data bits per OFDM symbol (NDBPS). Mode selection signal 91 may also indicate a particular channelization for the corresponding mode that provides a channel number and corresponding center frequency. Mode select signal 91 may further indicate a power spectral density mask value and a number of antennas to be initially used for a MIMO communication.

Baseband processing module 63, based on mode selection signal 91, produces one or more outbound symbol streams 95 from outbound data 93. For example, if mode selection signal 91 indicates that a single transmit antenna is being utilized for the particular mode that has been selected, baseband processing module 63 produces a single outbound symbol stream 95. Alternatively, if mode selection signal 91 indicates 2, 3 or 4 antennas, baseband processing module 63 produces respective 2, 3 or 4 outbound symbol streams 95 from outbound data 93.

Depending on the number of outbound symbol streams 95 (e.g. 1 to n) produced by baseband processing module 63, a corresponding number of RF transmitters 70 are enabled to convert outbound symbol stream(s) 95 into outbound RF signals 97. Generally, each RF transmitter 70 includes a digital filter and up sampling module, a digital to analog conversion module, an analog filter module, a frequency up conversion module, a power amplifier, and a radio frequency bandpass filter. RF transmitters 70 provide outbound RF signals 97 to T/R module 80, which provides each outbound RF signal 97 to a corresponding antenna 81.

When radio 60 is in the receive mode, T/R module 80 receives one or more inbound RF signals 96 via antenna(s) 81 and provides signal(s) 96 to respective one or more RF receivers 71.

RF receiver(s) 71, based on settings provided by channel bandwidth adjust module 66, converts inbound RF signals 96 into a corresponding number of inbound symbol streams 94. The number of inbound symbol streams 94 corresponds to the particular mode in which the data was received. Baseband processing module 63 converts inbound symbol streams 94 into inbound data 92, which is provided to host 40 via host interface 62.

The wireless communication device of FIG. 2 may be implemented using one or more integrated circuits. For example, host 40 may be implemented on one integrated circuit, baseband processing module 63 and memory 65 may be implemented on a second integrated circuit, and the remaining components of radio 60 (less the antennas 81) may be implemented on a third integrated circuit. As an alternative embodiment, baseband processing module 63 and radio 60 may be implemented on a single integrated circuit. In another embodiment, processing module 50 of host 40 and baseband processing module 63 may be a common processing device implemented on a single integrated circuit. Furthermore, memory 52 and memory 65 may be implemented on the same memory device and/or on the same integrated circuit as the common processing modules of processing module 50 and baseband processing module 63. It is be noted that other embodiments may be implemented with the various units of FIG. 2.

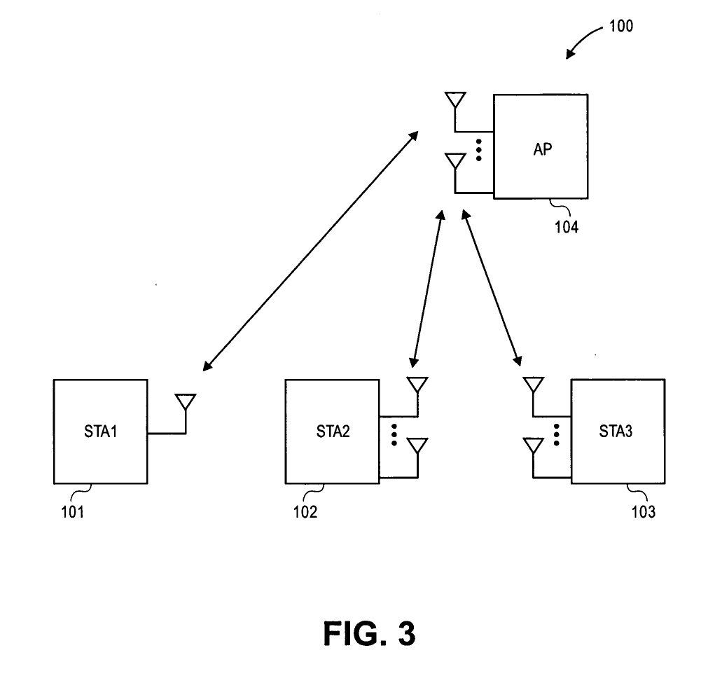

The various embodiments of the wireless communication device of FIG. 2 may be implemented in a transmitter and/or a receiver utilized for wireless communications. Typically, the communication is both ways so that the two units communicating typically will employ a transceiver in order to send and receive data. The multiple RF transmitters 70 and RF receivers 71 allow the device of FIG. 2 to be utilized in a multiple antenna transceiver system. FIG. 3 shows one particular example when wireless communication is achieved using multiple antennas between a particular access point and a plurality of stations that communicate with the access point.

In FIG. 3 a wireless communication system 100 is shown that includes three stations (STAS) 101, 102 and 103 (also noted as STA1, STA2 and STA3, respectively) communicating with a common access point (AP) 104. Only three stations 101-103 are shown in the example for illustrative purpose, but many other stations may be present in system 100. AP 104 may be one of the APs shown in FIG. 1, while stations 101-103 may correspond to respective devices that communicate with the APs or each other in FIG. 1. It is to be noted that system 100 need not be limited to system 10 of FIG. 1.

In the example embodiment of FIG. 3, AP 104 is capable of communicating using a MIMO protocol, as well as a single antenna protocol. Thus, STA1 is shown having only one antenna and communicates with AP 104 utilizing a single antenna protocol, such as IEEE 802.11a, IEEE 802.11b, IEEE 802.11g (hereinafter referred to as 802.11 a/b/g). STA2 and STA3 are shown having multiple antennas and are capable of communicating with AP 104 utilizing a MIMO protocol. The single antenna protocols are herein after referred to as legacy protocol, since this communicating format is well known and currently in use. It is to be noted that system 100 may operate by not having any legacy stations, such as STA1, present in the system. It is also to be noted that multiple antenna stations, such as STA2 and STA3, may revert to communicating using a legacy protocol, if these stations cannot communicate using a MIMO protocol.

STA2 and STA3 are MIMO devices capable of using MIMO communication technology to communicate with AP 104. Thus, multiple antennas are shown for these devices and one or more of these devices may operate using radio 60 of FIG. 2. However, since a MIMO communication standard has not been developed yet and/or agreed upon by the relevant industry, no such standard is assumed to be currently available for system 100. It is to be noted that IEEE 802.11n (hereinafter referred to as 802.11n) is the nomenclature currently given for labeling a future MIMO standard and, accordingly, the description below presumes 802.11n as the new MIMO standard. However, the embodiments of the invention may be implemented with any one of a variety of future MIMO protocols and/or standards.

Until a MIMO standard is established, various manufacturers of wireless communication devices, including integrated circuit vendors, may utilize a protocol which is proprietary to the product vendor, so that MIMO communication format may be implemented even without an available communication standard. Thus, until a standard is available, a number of MIMO protocols may be in use with the various communication devices and integrated circuit chips. These different MIMO protocols are referred to as proprietary MIMO, signifying a proprietary format applicable to one vendor or a group of vendors. Generally, it is an intent to have these devices upgrade to a new industry-wide MIMO standard (such as the 802.11n standard) when one is established.

Unlike SISO communication protocols, where 802.11 a, b and g formats may be readily differentiated, devices may not be able to differentiate between proprietary MIMO protocols and the new MIMO standard, because some of the proprietary formats may be so similar to the new standard that a conflict may arise between the two MIMO formats. Furthermore, because not all of the devices within a system may be upgraded at the same time, situations arise where some devices operate using the new MIMO standard, but others are not capable of doing so. Accordingly, system 100 exemplifies a situation in which some of the devices are upgraded to the new MIMO standard and operate in the same environment with devices that have not received the upgrade, even if the two MIMO formats conflict.

As noted above STA1 operates using a single antenna legacy communication protocol, such as 802.11 a/b/g. STA2 and STA3 operate using a proprietary MIMO protocol, with the ability to upgrade to the new MIMO standard when it is available. AP 104 is capable of communicating in either the legacy or the proprietary mode. For example, if radio 60 of FIG. 2 is implemented in AP 104, mode selection signal 91 may be used to switch between the two modes based on the STA device. When the new standard is upgraded into AP 104, mode selection signal 91 may select among the three formats for transmission from radio 60.

Accordingly, until a new MIMO protocol is available, AP 104 includes firmware that is capable of operating using a legacy format and a proprietary MIMO protocol. In one example application, AP 104 includes a set of software to have the device operate in legacy mode (such as 802.11 a/b/g) and a second set of software to have the device operate in proprietary MIMO mode. In one embodiment, separate tables are implemented to contain the software for operating in the two modes. AP 104 also has allocated sufficient space to contain software to operate in the new MIMO standard (such as 802.11n) when it is established. AP 104 may be designed and manufactured to accommodate the necessary upgraded applications and drivers, when the new MIMO standard is available. In one embodiment, the added upgrade to AP 104 is in addition to the original two communication formats, so that when upgraded, AP 104 may operate in legacy mode, proprietary MIMO and/or the new MIMO standard.

When the upgrade is installed in AP 104, STA2 and STA3 also requires the upgrade to the new MIMO standard in order to communicate with AP 104 using the new MIMO standard format. However, in many instances, not all stations would be upgraded at the same time to allow all of the stations to communicate with AP 104 using the new MIMO format. Accordingly, with some stations upgraded, while others are not, it is advantageous to have AP 104 communicate using both the proprietary MIMO standard format and the new MIMO format, in order for all of the stations within system 100 communicate with AP 104.

However, as noted above, it is possible that there may be a conflict between the proprietary MIMO and the new MIMO standard, so that only one of the two MIMO formats may be utilized in communicating between AP 104 and each of the stations. In those instances, AP 104 may be operational to communicate with a given STA using one of the two MIMO formats, but not both. Because the legacy format is sufficiently different, AP 104 may utilize the legacy format as a default communication mode in communicating with a STA, if the MIMO formats are not available.

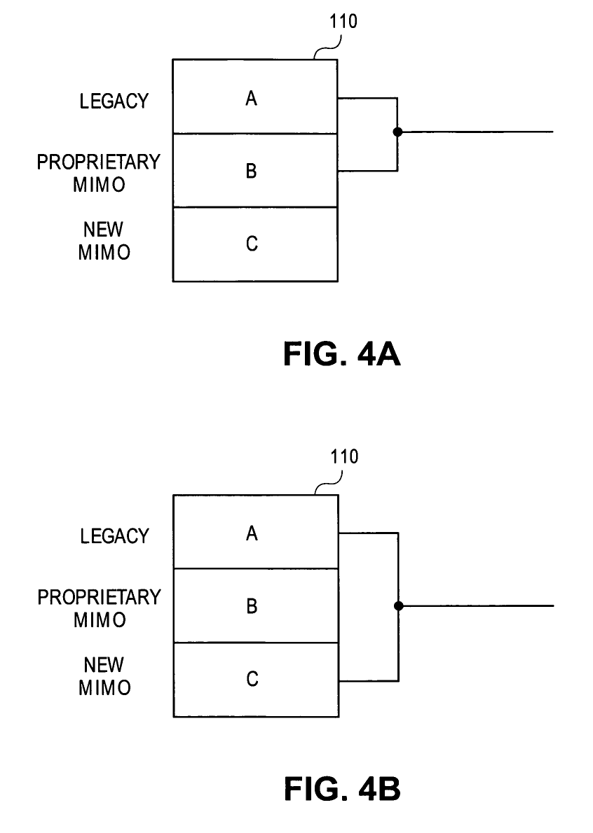

FIGS. 4A and 4B illustrate the usage of different formats by AP 104. AP 104 includes a memory 110 (or an equivalent storage device) that has three storage locations for storing relevant software to have AP 104 operate in one of three modes. In the embodiment shown, tables A, B and C correspond to storage locations containing software for operating AP 104 in legacy mode (Table A), proprietary MIMO mode (Table B) and the new MIMO standard mode (Table C). Note that table C is only filled after the new MIMO standard is available.

Thus, FIG. 4A shows an operational state of AP 104 prior to the upgrading of AP 104 with the new MIMO standard. When Table C is not filled with the upgrade, AP 104 communicates with the various STAs within system 100 by using either the legacy format or proprietary MIMO format. That is, if a particular STA is capable of communicating with AP 104 using proprietary MIMO, then Table B is selected. If a particular STA is not capable of communicating using proprietary MIMO, then Table A and the legacy format is selected.

FIG. 4B shows an operational state of AP 104 once the upgrade to the new MIMO standard is achieved. Once the new MIMO standard is available and loaded in Table C, AP 104 attempts to communicate with a given STA using the new MIMO standard. MIMO communication is successful only if the particular STA is upgraded as well. Otherwise AP 104 reverts to the default legacy format to communicate with a STA that is not upgraded with the new MIMO standard, unless the proprietary MIMO format is available as described below.

When the new MIMO standard is loaded in Table C, AP 104 initializes to the new MIMO format in communicating with the STAs. When a given STA does not have the new MIMO capability, but has the ability to use the proprietary MIMO, AP 104 may select the proprietary MIMO mode. The legacy mode is selected, if a given station is not capable of communicating using one of the two MIMO modes. As noted above, not all of the STAs may be upgraded to the new MIMO standard. For example, within system 100, STA2 may be upgraded but STA3 may not. Accordingly, AP 104 may communicate with STA2 using Table C, but not STA3. AP 104 would revert to the legacy mode unless STA3 is capable of communicating in proprietary MIMO mode using Table B. In order to make the correct selection, AP 104 determines if a particular STA has or has not upgraded to the new MIMO standard. However, if the STA has not upgraded, but is capable of communicating in the proprietary MIMO mode, then AP 104 uses the proprietary MIMO mode for communication. Only when the STA is not capable of communicating in one of the two MIMO modes, does AP 104 revert to the legacy mode for communication.

From a given STA's viewpoint, it may not know when AP 104 is upgraded, unless AP 104 signals the upgrade to the STA. In other embodiments, the proprietary MIMO software in the STA may be able to identify that AP 104 has upgraded. When the upgrade is noted by a STA, that STA may inform the user or obtain the upgrade through some means, such as a download from a vendor to obtain the upgrade. In any event, there may be situations where STA(s) do not upgrade. In those instances it may be advantageous for the STA to continue to use the proprietary MIMO format in communicating with AP 104. Essentially, the non-upgraded STA continues operating in the proprietary MIMO mode, be it for performance or some other reason. In the above example, STA2 transitions to the new MIMO mode to communicate with AP 104, but STA3 protects the continued use of the proprietary MIMO mode in communicating with AP 104.

A variety of techniques may be implemented to protect the proprietary MIMO format for those STAs not upgraded. Because AP 104 is the central point, AP 104 controls how the communication is effected. AP 104 may select which mode to use to communicate with each given STA. Alternatively, each STA may inform AP 104 how AP 104 may communicate with the particular STA.

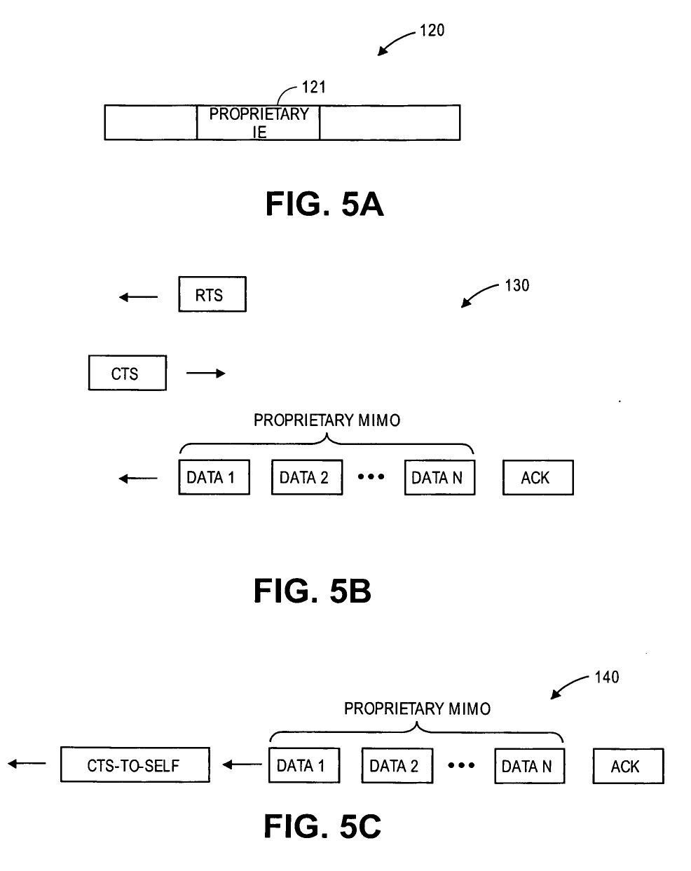

In one embodiment, a beacon from AP 104 and a coded response from the STA allows for two way communication to determine which mode of operation is usable between the two units. It is to be noted that various beacons are used to initialize the communication link between an access point (such as a router) and a STA. In one embodiment, a beacon from AP 104 includes a proprietary information element (IE), that includes information about the upgraded state of AP 104. The proprietary IE is illustrated in FIG. 5A.

In FIG. 5A, a proprietary IE 121 is shown as part of beacon 120 sent from AP 104 to initiate communication with the various STAs within system 100. Typically, proprietary IE 121 is sent in a beacon that includes other frames, such as PLCP (Physical Layer Convergence Procedure) frames. In some embodiments the proprietary IE is read only by those STAs that are set up to read such proprietary IE. For example, devices from a given vendor may use the proprietary IE to transfer vendor proprietary information. Proprietary IE of one vendor may be disregarded by devices manufactured by other vendors. No matter how other devices receive beacon 120, proprietary IE 121 is sent -from AP 104 and the information present in proprietary IE 121 is extracted by the receiving STA, if it is capable of identifying the proprietary IE 121.

In the example system 100, it is presumed that STA 103 is capable of reading proprietary IE 121 that is in beacon 120 sent from AP 104. That is, whether at time of manufacture or subsequently obtained, STA 103 includes firmware capable of extracting proprietary IE 121. Proprietary IE 121 includes information to notify STAs extracting proprietary IE 121 that AP 104 is now loaded with the upgrade to the new MIMO standard. Because STA 103 has not been upgraded yet and wants to protect the existing proprietary MIMO mode of operation, it responds with a unique code that is identified by AP 104. The unique code from STA3 informs AP 104 to continue using the proprietary MIMO mode between the two devices. If STA3 does not respond to protect the proprietary MIMO mode, AP 104 would assume that STA3 does not have the capability to communicate using the new MIMO standard format (e.g., that STA3 has not been upgraded) and would revert to the use of the default legacy mode.

A variety of unique codes may be used between STA3 and AP 104 to establish a communication link to inform AP 104 that STA3 wants to use its proprietary MIMO format for the MIMO communication between the two devices, even though AP 104 is upgraded. In one embodiment, STA3 responds to the proprietary IE 121 with a pre-arranged code or signal to notify AP 104 to continue the use of the proprietary MIMO mode with STA3. A variety of signal sequences may be used between the two devices (AP 104 and STA3) and two examples are noted below.

In the first example, RTS+CTS (Request To Send+Clear To Send) signals are used as the communication code between the STA3 and AP 104. In the second example a CTS-to-self (Clear to Send-to-self) signal is used by STA3 to notify AP 104 to use the proprietary MIMO mode.

Generally, in existing communication protocols (such as for 802.11b compliant protocol) an RTS frame is used by the initiator to indicate a “request to send” and a CTS frame, identifying the initiator, is used to indicate that it is “clear to send.” Either the CTS or RTS frame is used in a network allocation vector with these existing protocols. Accordingly, when receiving the proprietary IE 121 from AP 104 (which indicates that AP 104 has the new MIMO format available for communication), STA3 responds with a RTS signal, indicating that STA3 wants to respond using the proprietary MIMO. AP 104, upon receiving the RTS, then sends out a CTS signal, which indicates to STA3 that it may send the data using the proprietary MIMO format. Upon receiving the CTS signal from AP 104, STA3 sends the data. Thus, RTS+CTS provide the hand-shaking link to allow STA3 to maintain the proprietary MIMO format with AP 104.

In the CTS-to-self example, STA3 responds to the proprietary IE by sending out a CTS signal which identifies itself. Because a CTS frame from an initiator identifies the recipient (to inform the recipient that it is clear to send data), a CTS-to-self signal (which essentially is a clear to send indication noting STA3's own address) is a condition not allowed in existing protocols for normal communications. However, AP 104 interprets this not allowed condition as an indication that STA3 will be sending the following data using the proprietary MIMO format.

Accordingly, as shown in FIGS. 5B and 5C, RTS+CTS and CTS-to-self responses are shown in use in response to proprietary IE 121 to protect the proprietary MIMO mode for STA3. As noted in FIG. 5B, in response to receiving proprietary IE 121 indicating that AP 104 intends to operate in the new MIMO mode, STA3 responds by sending an allocation vector 130 that includes RTS frames. AP 104 then responds with the CTS signal. Upon receiving, STA3 responds by sending one or more frames of data that uses its proprietary MIMO format. The number of frames to be sent following the RTS+CTS frames may be fixed or variable. Allocation vector 130 may include information as to how many frames of data follows the RTS+CTS frames. Allocation vector 130 may include its own proprietary IE frame to convey the information on the number of data frame that will follow. An acknowledgment (ACK) frame may also be used to indicate the end of the transmission.

Likewise, as shown in allocation vector 140 of FIG. 5C, a CTS-to-self frame may be used to perform the equivalent function as the RTS+CTS frames. However, with CTS-to-self, the data is sent prior to a reply from AP 104. CTS-to-self frame may be followed by fixed or variable number of data frames as noted above with RTS+CTS. Again, proprietary IE and ACK frames may be present as well. With the CTS-to-self technique, data may be sent before there is a reply from AP 104. STA3 presumes that AP 104 will interpret the CTS-to-self frame as an instruction to AP 104 to use the proprietary MIMO for the following transmitted data.

It is to be noted various combinations of signals, frames, and other means for communicating between the two devices may be practiced. Established protocols may be used or forbidden (not allowed) conditions may be used to indicate to AP 104 that STA3 desires to communicate using the existing proprietary MIMO format.

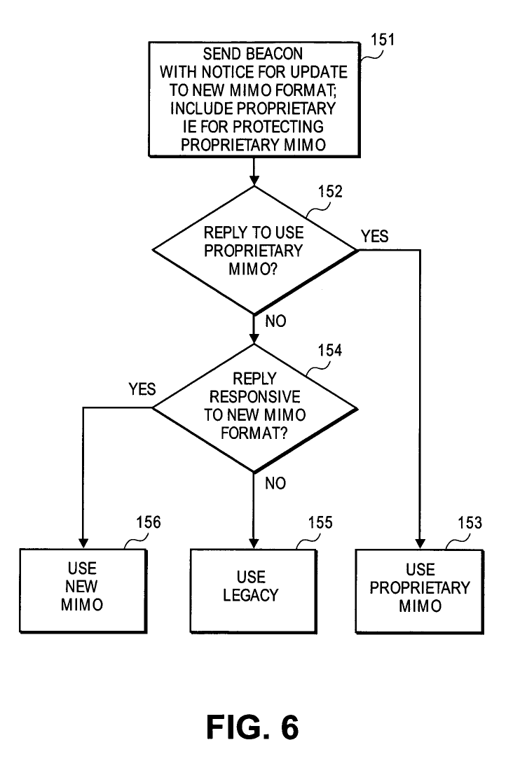

FIG. 6 illustrates an operation of the firmware in AP 104 in determining if any of the STAs want to maintain the proprietary MIMO mode of communication. After sending out proprietary IE 121 frame in beacon 120 (block 151), AP 104 looks for a reply that includes either a RTS frame (to which it responds with a CTS frame) or CTS-to-self frame from the particular STA (block 152). If RTS+CTS or CTS-to-self condition is present, then proprietary MIMO is protected and AP 104 uses the proprietary MIMO mode with the data sent from that station (block 153).

If the reply from the STA does not have the RTS reply for proprietary MIMO or CTS-to-self reply, AP 104 looks to determine if the STA responding has identifying frame(s) set for the new MIMO standard (block 154). If the new MIMO standard identifying frame is present in the response, then AP 104 uses the new MIMO standard (block 155) for data transfer. If no MIMO identifying frame is present, AP 104 may revert to legacy mode of operation with the responding STA (block 156).

In the above example of system 100, STA2 responds with a new MIMO identifying frame, since STA2 is upgraded and may communicate in the new MIMO mode. STA3 has not been upgraded, so it responds with RTS frame or CTS-to-self frame to protect its proprietary MIMO mode of operation. AP 104 switches to use the proprietary MIMO mode when communicating with STA3.

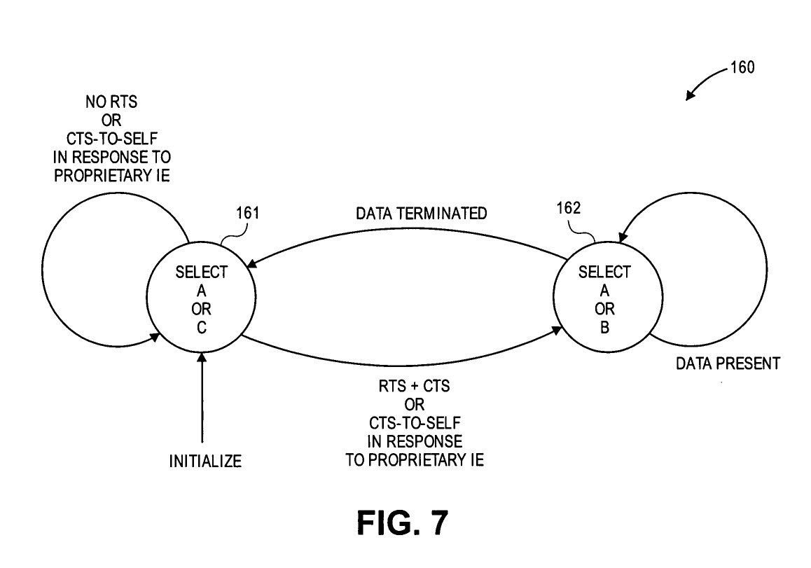

FIG. 7 shows one embodiment of a state machine used with AP 104 to select between the proprietary MIMO and new MIMO modes of operation. State machine 160 is shown with two states 161 and 162. Once the upgrade to a new MIMO standard has been achieved, state machine 160 initializes into state 161. In state 161, Table A or Table C (see FIG. 4B) is utilized to communicate with a particular STA. When a RTS frame indicating proprietary MIMO (RTS+CTS situation) or CTS-to-self frame is detected from a STA, state machine 160 changes to state 162. In state 162, Table A or Table B (see FIG. 4A) is utilized to communicate with a particular STA, as long as data is present. Once the data burst has ended, state machine 160 reverts to state 161. It is to be noted that this embodiment of state machine 160 is but just one implementation of practicing the invention. Furthermore, state machine 160 may be implemented in hardware, software or a combination of both.

In various implementations of the invention, it is to be noted that a particular vendor may design existing AP and STA products with the upgrade in mind. These products may include various “hooks” to allow for the protection of existing proprietary MIMO mode of operation, once a new MIMO standard is made available to the industry. Once an AP device is upgraded to the new MIMO standard for communicating, the hook may be used to elicit a certain response from a given STA to protect the proprietary MIMO mode for communicating with those STAs not yet upgraded. In the description above, a proprietary IE in a beacon is used as the hook and RTS+CTS or CTS-to-self conditions were noted as two examples of unique codes to inform the AP to use of the proprietary MIMO mode for the following data frames. It is to be noted that other hooks and unique codes may be utilized.

Thus, a technique to provide proprietary MIMO format in a product and ability to support a new standard when the new standard is developed is described.

I claim:

1. A method comprising:
upgrading from a first multiple-input-multiple-output (MIMO) wireless communication format to a second MIMO wireless communication format in a device that communicates with multiple stations; and
transmitting a signal from the device to the multiple stations, in which the signal includes an identifier that the device is upgraded from the first MIMO format to the second MIMO format.

2. The method of claim 1 wherein upgrading includes upgrading from a non-standard MIMO wireless communication format to an industry standard MIMO wireless communication format.

3. The method of claim 1 wherein upgrading includes upgrading from a proprietary MIMO wireless communication format to an industry standard MIMO wireless communication format.

4. The method of claim 1 wherein upgrading includes upgrading from a proprietary MIMO wireless communication format to an industry standard 802.11n MIMO wireless communication format.

5. The method of claim 3 wherein transmitting includes transmitting a beacon signal from the device to the multiple stations, in which the beacon signal includes the identifier to inform the stations that the device is upgraded.

6. The method of claim 3 wherein transmitting includes transmitting a beacon signal from the device to the multiple stations, in which the beacon signal includes a proprietary identifier to inform one or more stations that are capable of decoding the proprietary identifier that the device is upgraded.

7. The method of claim 3 wherein transmitting includes transmitting a beacon signal from the device to the multiple stations, in which the beacon signal includes a proprietary information element associated with a manufacturer of the device in the identifier to inform one or more stations that are capable of decoding the proprietary information element that the device is upgraded.

8. A method comprising:
upgrading from a first multiple-input-multiple-output (MIMO) wireless communication format to a second MIMO wireless communication format in a device that communicates with multiple stations;
transmitting a first signal from a first device to a second device, in which the first signal includes an identifier that the first device is upgraded to the second MIMO format;
receiving a second signal from the second device that the second device is not upgraded to the second MIMO communication format and that the first device is to continue communicating with the second device using the first MIMO wireless communication format.

9. The method of claim 8 wherein upgrading includes upgrading from a non-standard MIMO wireless communication format to an industry standard MIMO wireless communication format.

10. The method of claim 8 wherein upgrading includes upgrading from a proprietary MIMO wireless communication format to an industry standard MIMO wireless communication format.

11. The method of claim 8 wherein upgrading includes upgrading from a proprietary MIMO wireless communication format to an industry standard 802.11n MIMO wireless communication format.

12. The method of claim 8 wherein transmitting the first signal includes transmitting a beacon signal from the first device to the second device, in which the beacon signal includes the identifier to inform the second device that the first device is upgraded.

13. The method of claim 8 wherein transmitting the first signal includes transmitting a beacon signal from the first device to the second device, in which the beacon signal includes a proprietary identifier to inform the second device that the first device is upgraded.

14. The method of claim 8 wherein transmitting the first signal includes transmitting a beacon signal from the first device to the second device, in which the beacon signal includes a proprietary information element associated with a manufacturer of the first device in the identifier to inform the second device that the first device is upgraded.

15. The method of claim 8 wherein receiving the second signal includes receiving a request-to-send signal as a coded signal in response to the first signal, the coded signal to indicate that the first and second devices are to utilize the first MIMO wireless communication format to communicate, since the second device is not upgraded to the second MIMO wireless communication format, and wherein the first device responds with a clear-to-send using the first MIMO wireless communication format signal.

16. The method of claim 8 wherein receiving the second signal includes receiving a clear-to-send signal, that indicates its own address of the second device, as a coded signal in response to the first signal, the coded signal to indicate that the first device is to utilize the first MIMO wireless communication format for subsequent data transmission from the second device, since the second device is not upgraded to the second MIMO wireless communication format.

17. A method comprising:
receiving a first signal that includes an identifier from a device, in which the identifier includes information that the device is upgraded from a first multiple-input-multiple-output (MIMO) wireless communication format to a second MIMO wireless communication format;
transmitting a second signal in reply to the first signal that the first MIMO wireless communication format is to be used in decoding data being transmitted following the second the signal; and
transmitting data to the device using the first MIMO wireless communication format.

18. The method of claim 17 wherein receiving the first signal includes receiving the identifier with information that the device is upgraded from a proprietary MIMO wireless communication format to an industry standard MIMO wireless communication format.

19. The method of claim 17 wherein receiving the first signal includes receiving the identifier with information that the device is upgraded from a proprietary MIMO wireless communication format to an industry standard 802.1 In MIMO wireless communication format.

20. The method of claim 18 wherein receiving the first signal includes receiving a beacon signal.

21. The method of claim 20 wherein receiving the beacon signal includes receiving a proprietary information element associated with a manufacturer of the device to inform recipients of the beacon signal capable of decoding the proprietary information element that the device is upgraded.

22. The method of claim 21 wherein transmitting the second signal includes transmitting a request-to-send signal as a coded signal in response to the first signal, the coded signal to indicate that the device is to utilize the first MIMO wireless communication format to communicate.

23. The method of claim 21 wherein transmitting the second signal includes transmitting a clear-to-send signal, that indicates its own address as sender, as a coded signal in response to the first signal, the coded signal to indicate that the device is to utilize the first MIMO wireless communication format for subsequent data transmission.
